(19) United States
(12) Patent Application Publication
(10) Pub. No.: US 2022/0277266 A1
(43) Pub. Date: Sep. 1, 2022

(54) SYSTEM AND METHOD FOR REAL-TIME HEALTHCARE CLAIM ADJUSTMENT

(71) Applicant: Cognizant Trizetto Software Group, Inc., Englewood, CO (US)

(72) Inventors: Elliott Papadakis, Englewood, CO (US); Rosalind Therrien, Englewood, CO (US); Alyson Broxston, Englewood, CO (US)

(21) Appl. No.: 17/682,438

(22) Filed: Feb. 28, 2022

Related U.S. Application Data
(60) Provisional application No. 63/154,905, filed on Mar. 1, 2021.

(51) Int. Cl. G06Q 10/10; G06Q 40/08; G06F 9/445; G06F 9/54

(52) U.S. Cl. CPC G06Q 10/10; G06Q 40/08; G06F 9/44505; G06F 9/541

(57) ABSTRACT

A system and a method for real-time automated healthcare claim adjustment is provided. The invention provides for transmitting a pre-authorization request associated with the healthcare claims adjustment based on a first set of rules. The invention provides for determining a need for authorization for the pre-authorization request based on a second set of rules. The need for authorization for the pre-authorization request is determined as a first action response. The invention provides for performing a second action response based on a third set of rules, subsequent to the first action response, for determining whether the healthcare claims adjustment request is pending for review. The invention provides for populating a pre-defined servicing field with data associated with the first user type for performing healthcare claims adjustment. External devices are triggered to execute actions associated with healthcare claims adjustment based on the populated data.

### FIELD OF THE INVENTION

The present invention relates generally to the field of healthcare systems and more particularly, the present invention relates to a system and a method for cloud-based real-time automated healthcare claim adjustment.

### BACKGROUND OF THE INVENTION

For healthcare claim adjustments a patient, typically, requires pre-authorization prior to processing any such adjustment. Existing pre-authorization solutions for healthcare claim adjustments employ custom integration provisions to core systems. Requests for pre-authorization are processed based on pre-defined rules, and the request may either be approved or denied. Further, the approval or denial of a request is shared with core systems for utilization for healthcare claims payment, which is time consuming and require large investments, thereby making the entire process cumbersome for the patient.

Also, typically, authorization of healthcare claim adjustment requests are carried out manually, thereby making the process slow. Further, it has been observed that for every new patient, a customized healthcare claim adjustment solution has to be generated, which increases overall cost of the solution and causes difficulty in maintaining the customized healthcare claim adjustment solution in a Software as a Service (SaaS) environment.

In light of the above drawbacks, there is a need for a system and a method which provides for optimized healthcare claims adjustment in real-time. There is a need for a system and a method which provides for automating healthcare claim adjustment request generation and authorization. Further, there is a need for a system and a method which provides for healthcare claim adjustment authorizations which are consistent, predictable, streamlined, easy to implement and maintain. Furthermore, there is a need for a system and a method which provides for fast and cost-effective healthcare claim adjustments.

### SUMMARY OF THE INVENTION

In various embodiments of the present invention, a system for automated healthcare claims adjustment in real-time is provided. The system comprises a memory storing programing instructions, a processor executing the program instructions stored in the memory and a healthcare claims adjustment engine executed by the processor. The healthcare claims adjustment engine is configured to transmit a pre-authorization request associated with a healthcare claims adjustment based on a first set of rules. One or more requirements associated with the pre-authorization requests are verified using a pre-authorization checking Application Programing Interface (API). The healthcare claims adjustment engine is configured to determine a need for authorization for the pre-authorization request based on a second set of rules. The need for authorization for the pre-authorization request is determined as a first action response. Further, the healthcare claims adjustment engine is configured to perform a second action response based on a third set of rules, subsequent to the first action response, for determining whether the healthcare claims adjustment request is pending for review. Lastly, the healthcare claims adjustment engine is configured to populate a pre-defined servicing field with data associated with the first user type for performing healthcare claims adjustment. External devices are triggered to execute actions associated with healthcare claims adjustment based on the populated data.

In various embodiments of the present invention, a method for automated healthcare claims adjustment in real-time is provided. The method is implemented by a processor executing program instructions stored in a memory. The method comprises transmitting a pre-authorization request associated with the healthcare claims adjustment based on a first set of rules. One or more requirements associated with the pre-authorization requests are verified using a pre-authorization checking Application Programing Interface (API). Further, the method comprises determining a need for authorization for the pre-authorization request based on a second set of rules. The need for authorization for the pre-authorization request is determined as a first action response. Further, the method comprises performing a second action response based on a third set of rules, subsequent to the first action response, for determining whether the healthcare claims adjustment request is pending for review. Lastly, the method comprises populating a pre-defined servicing field with data associated with the first user type for performing healthcare claims adjustment. External devices are triggered to execute actions associated with healthcare claims adjustment based on the populated data.

In various embodiments of the present invention, a computer program product is provided. A non-transitory computer-readable medium having computer program code stored thereon, the computer-readable program code comprising instructions that, when executed by a processor, causes the processor to transmit a pre-authorization request associated with the healthcare claims adjustment based on a first set of rules. One or more requirements associated with the pre-authorization requests are verified using a pre-authorization checking Application Programing Interface (API). Further, a need for authorization is determined for the pre-authorization request based on a second set of rules. The need for authorization for the pre-authorization request is determined as a first action response. Further, a second action response is performed based on a third set of rules, subsequent to the first action response, for determining whether the healthcare claims adjustment request is pending for review. Lastly, a pre-defined servicing field is populated with data associated with the first user type for performing healthcare claims adjustment. External devices are triggered to execute actions associated with healthcare claims adjustment based on the populated data.

### BRIEF DESCRIPTION OF THE ACCOMPANYING DRAWINGS

The present invention is described by way of embodiments illustrated in the accompanying drawings wherein:

FIG. 1 illustrates a detailed block diagram depicting a healthcare claims adjustment system, in accordance with an embodiment of the present invention;

FIG. 2 illustrates a screenshot of a Graphical User Interface (GUI) rendered at a first user type's end depicting a pre-defined servicing field associated with the first user type, in accordance with an embodiment of the present invention;

FIG. 3 illustrates a screenshot of a GUI depicting a dialogue box providing no authorization need for a first level determination of authorization requirements, in accordance with an embodiment of the present invention;

FIG. 4 and FIG. 4A is a flowchart illustrating a method for healthcare claims adjustment, in accordance with an embodiment of the present invention; and

FIG. 5 illustrates an exemplary computer system in which various embodiments of the present invention may be implemented.

### DETAILED DESCRIPTION OF THE INVENTION

The present invention discloses a system and a method for optimized healthcare claims adjustment in real-time. In particular, the present invention provides for a system and a method for a cloud- based real-time healthcare claims adjustment solution in an automated manner. The present invention provides for a system and a method for automated request generation and authorization determination. The present invention provides for a system and a method for a bidirectional integration between a patient and a healthcare organization based on a common integration layer. Further, the present invention provides for a system and a method for a multi-user Software as a Service (SaaS) solution with unique client self-service tools and utilities. Further, the present invention provides for a system and a method for rendering updated information regarding patient eligibility and benefits for healthcare claims adjustment. Furthermore, the present invention provides for a system and a method for flagging healthcare claim adjustment requests as ‘urgent’ or ‘not urgent’ based on one or more pre-defined rules.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

FIG. 1 is a detailed block diagram illustrating a healthcare claims adjustment system 100 (system 100), in accordance with various embodiment of the present invention.

In an embodiment of the present invention, the system 100 is configured with a built-in mechanism to automate healthcare claims adjustment in real-time. The system 100 is configured to operate using one or more pre-defined rules for carrying out automated healthcare claims adjustment. The system 100 is configured to manage application setup, security, access controls, administrative compliance, operational reporting configurations and healthcare claims adjustment reports. Further, the system 100 is a bi-directional system, integrable with core systems through a common integration layer.

In an embodiment of the present invention, the system 100 is a platform which may be implemented in a cloud computing architecture in which data, applications, services, and other resources are stored and delivered through shared data-centers. In an exemplary embodiment of the present invention, the functionalities of the system 100 are delivered to a user as Software as a Service (SaaS) or a Platform as a Service (PaaS) over the communication network (not shown).

In another embodiment of the present invention, the system 100 may be implemented as a client-server architecture. In this embodiment of the present invention, a client terminal accesses a server hosting the system 100 over a communication network. The client terminals may include but are not limited to a smart phone, a computer, a tablet, microcomputer with a Graphical user Interface (GUI) and application programming interface (API) capabilities or any other wired or wireless terminal. The server may be a centralized or a decentralized server.

In an embodiment of the present invention, referring to FIG. 1, the system 100 comprises a healthcare claims adjustment engine 102 (engine 102), a processor 104 and a memory 106. The engine 102 communicates with external devices 124 for triggering the external devices 124 to execute actions associated with healthcare claims adjustments. The engine 102 includes various units which operate in conjunction with each other for providing optimized healthcare claims adjustment in real-time in an automated manner. The various units of the engine 102 are operated via the processor 104 specifically programmed to execute instructions stored in the memory 106 for executing respective functionalities of the units of the engine 102, in accordance with various embodiments of the present invention.

In an embodiment of the present invention, the engine 102 comprises an authentication unit 108, a provider server 110, a reporting unit 112, a rules configuration unit 114, a payer server 116, a common integration unit 118, a core unit 120, a user device 122 and an electronic device 126. In an exemplary embodiment of the present invention, the reporting unit 112 and the rules configuration unit 114 may operate within the authentication unit 108 or outside the authentication unit 108. In an embodiment of the present invention, the reporting unit 112 is configured to render a Graphical User Interface (GUI) at a first user type's end on the electronic device 126 associated with the first user type, such as, a computer, a laptop, a smartphone, etc. In an embodiment of the present invention, the provider server 110 and the payer server 116 are in communication with each other via a communication network. The communication network may include, but is not limited to, a physical transmission medium, such as, a wire, or a logical connection over a multiplexed medium, such as, a radio channel in telecommunications and computer networking. The examples of radio channel in telecommunications and computer networking may include, but are not limited to, a local area network (LAN), a metropolitan area network (MAN) and a wide area network (WAN). Further, the user device 122 is an electronic device comprising a computer, a laptop and a smartphone.

In an embodiment of the present invention, the authentication unit 108 is configured to authenticate one or more first user types for providing access to the healthcare claims adjustment system 100 by providing administrative rights to the first user type. The first user type may include an administrative user or a provider, who manages the healthcare claims adjustment system 100. The first user type may use a Single Sign-On (SSO) functionality for accessing the system 100. In an exemplary embodiment of the present invention, the first user type manages healthcare claims adjustments of an eligible second user type, access control of the second user type and the second user type group, access rights of the second type of users group, reset and editing rights of the second user type. The second user type includes a patient or a payer whose healthcare claim needs to be adjusted.

In another embodiment of the present invention, the authentication unit 108 is configured to communicate with the rules configuration unit 114 for generating, configuring and developing one or more rules comprising a first set, a second set, a third set and a fourth set of rules based on pre-defined guidelines. Further, the one or more rules are implemented for carrying out healthcare claims adjustment operations in an automated manner, as elaborated later in the specification.

In an embodiment of the present invention, the provider server 110 is configured to communicate with the rules configuration unit 114 for automating execution of the one or more rules, thereby eliminating manual execution of the one or more rules. In an embodiment of the present invention, the provider server 110 is configured to invoke the payer server 116. In an exemplary embodiment of the present invention, the payer server 116, thereafter, communicates with the common integration unit 118 for carrying out real-time healthcare claims transaction updates, creating and updating healthcare claims adjustment documents, updating the core unit 120 with healthcare claims adjustment transaction status based on the one or more rules.

In an embodiment of the present invention, the core unit 120 is configured to provide bidirectional Application Programing Interfaces (APIs) for verifying one or more attributes associated with the second user type's healthcare claims adjustment requests, which are accessed by the second user type via the user device 122. The one or more attributes include, but are not limited to, eligibility of the second user type, healthcare claims coverage of the second user type and real-time identification of healthcare benefit plans, which aids in eliminating manual uploading of healthcare benefit plans, increasing automation efficiency and reducing administrative costs. The one or more claims adjustment requests may further include, but are not limited to, healthcare admission certificate requests and responses, referral requests and responses, healthcare services certification requests and responses, extending certification requests and responses and certification appeal requests and responses. Further, the core unit 120 is configured to provide access to first user type data for providing authorization to the first user type.

In operation, in an embodiment of the present invention, the user device 122 is configured to transmit a pre-authorization request associated with the healthcare claims adjustment based on a first set of rules. The common integration unit 118 receives the request and invokes a pre-authorization checking API via the APIs in the core unit 120. Further, one or more requirements associated with the pre-authorization requests are verified by the common integration unit 118 using the pre-authorization checking API. The API provides correct authorization of healthcare claims adjustment requirements and a first user type contract status, thereby increasing automation and eliminating duplicate processes.

In an embodiment of the present invention, the core unit 120 using the APIs determines whether authorization is needed or not for the pre-authorization request associated with the healthcare claims adjustment (such as, healthcare plan's contract and benefit terms) based on a second set of rules and flags the pre-authorization request as ‘urgent’ or ‘not urgent’ based on the second set of rules. A first action response is generated by the core unit 120 relating to a need for authorization for the pre-authorization request, which is received by the common integration unit 118. The common integration unit 118 generates a ‘no plan action’ response, if no authorization is needed.

In an embodiment of the present invention, the common integration unit 118 subsequent to the received first action response is configured to provide a second action response, based on a third set of rules, for determining whether the healthcare claims adjustment request is pending for review with a non-participating first user type. In an embodiment of the present invention, the common integration unit 118 is configured to determine the first user type's contract status including a participating (par) or a non-participating (non-par) first user type, using the API.

In another embodiment of the present invention, the API provided by the core unit 120 further comprises a procedure and revenue (REV) code number for comparison with the health plan's benefit terms and contract terms. In an exemplary embodiment of the present invention, first user type's ID data and pay-to-affiliate data associated with the first user type's contract status are also provided in the API by the core unit 120. In another exemplary embodiment of the present invention, if the first user type's ID data and the pay-to-affiliate data are not sent via the API by the core unit 120, then the authorization need is compared with a healthcare plan's benefit terms.

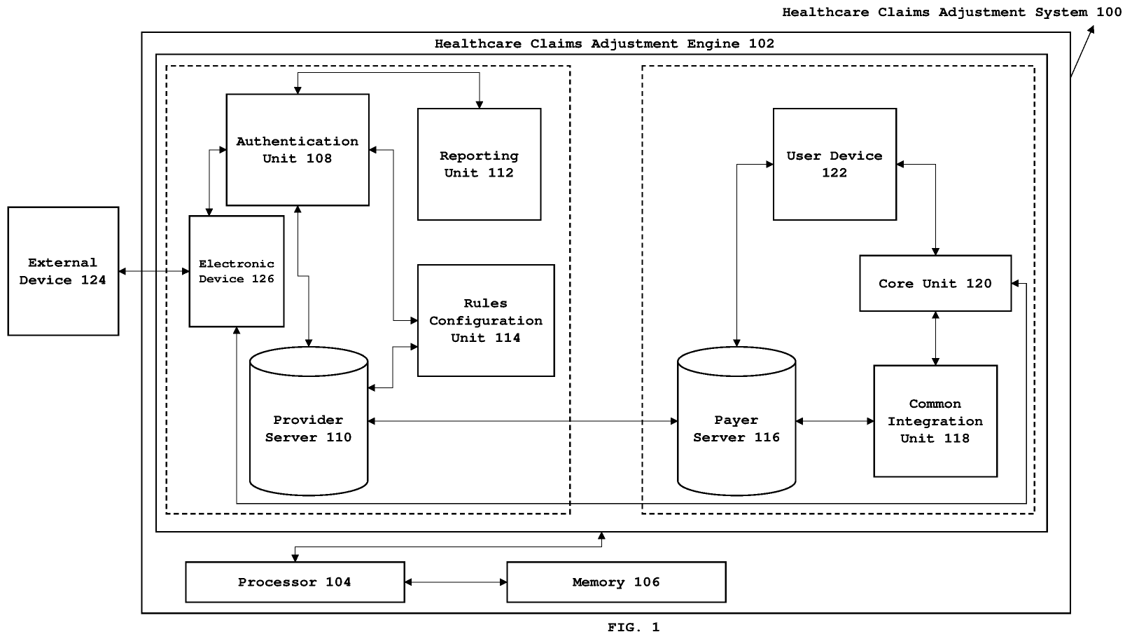

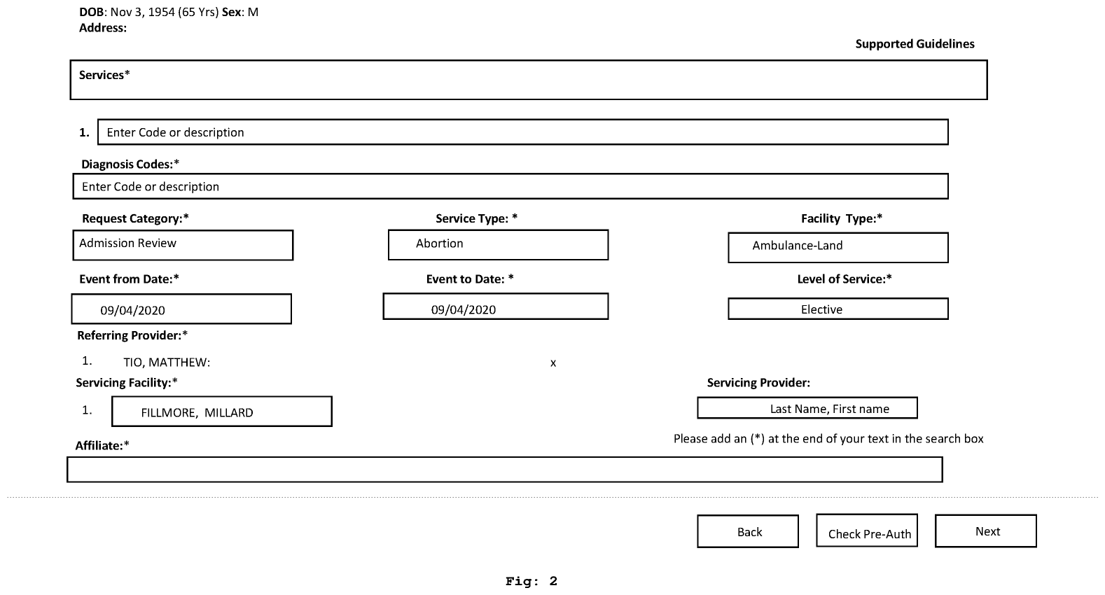

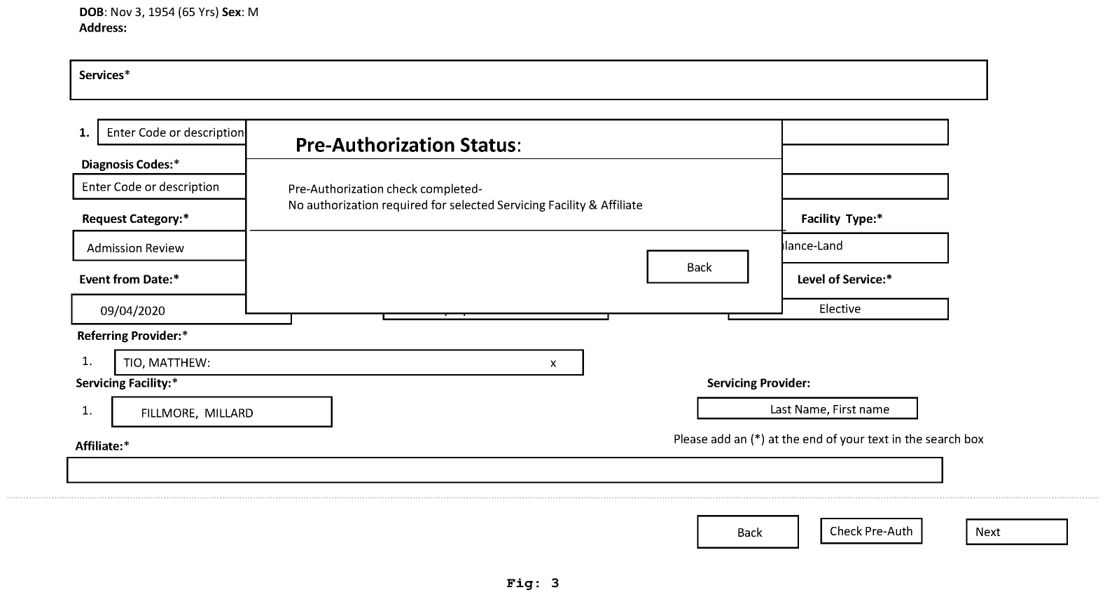

In an embodiment of the present invention, the API provided by the core unit 120 is implemented to search the first user type to populate a pre-defined servicing field with data associated with the first user type, via a GUI rendered on the electronic device 126 at the first user type's end, as illustrated in FIG. 2. The pre-defined servicing field comprises a servicing provider field or a servicing facility field. The pre-defined servicing field associated with the first user type is populated for performing healthcare claims adjustment. In an exemplary embodiment of the present invention, in the event more than one pay-to first user type affiliation is present for the first user type, then the results are displayed via the GUI rendered on the electronic device 126 at first user's end. The first user type is prompted to select the appropriate pay-to first user type affiliation option, when multiple results are provided. For example, a drop-down field is provided on the authorization UI for selecting an appropriate pay-to first user type affiliate data for the servicing provider. The selected pay-to first user type affiliate data is sent via the pre-authorization check API to the core unit 120 for a first level determination of authorization requirements for healthcare claims adjustment. In an exemplary embodiment of the present invention, in the event, it is determined that authorization is required, then one or more gold-carding rules are reviewed by the common integration unit 118 in addition to the one or more rules present in the rules configuration unit 114. In another exemplary embodiment of the present invention, in the event it is determined that no authorization is needed for healthcare claims adjustment, then a dialogue box providing no authorization need is rendered on the GUI at the first user type's end, as illustrated in FIG. 3. In an embodiment of the present invention, the electronic device 126 triggers the external devices 124 to execute actions associated healthcare claim adjustments based on the populated data.

In an embodiment of the present invention, the authentication unit 108 is configured to communicate with the reporting unit 112. The reporting unit 112 is configured to generate a detailed report for healthcare claims adjustment for the second user type. Further, the GUI provided by the reporting unit 112 renders generation, viewing, assessing, exporting and printing of detailed healthcare claims adjustment report and summary of the healthcare claims adjustment report based on a fourth set of rules. In an embodiment of the present invention, the reporting unit 112 may generate the healthcare claims adjustment report in an on-demand mode or a scheduled mode. In an exemplary embodiment of the present invention, the reporting unit 112 generates the healthcare claims adjustment report in an on-demand mode in the event the first user type selects a report generation option on the GUI. In another exemplary embodiment of the present invention, the reporting unit 112 generates the healthcare claims adjustment report in the scheduled mode in a pre-defined time period (e.g. report may be generated on a monthly basis). In various exemplary embodiments of the present invention, the generated reports include information including, but are not limited to, a list of second user types, access attempts of the second user type, access logs of the second user type, second user type activity logs and second user type rights. Advantageously, the generated reports aid in meeting operation management, security, regulatory compliance and administrative reporting requirements.

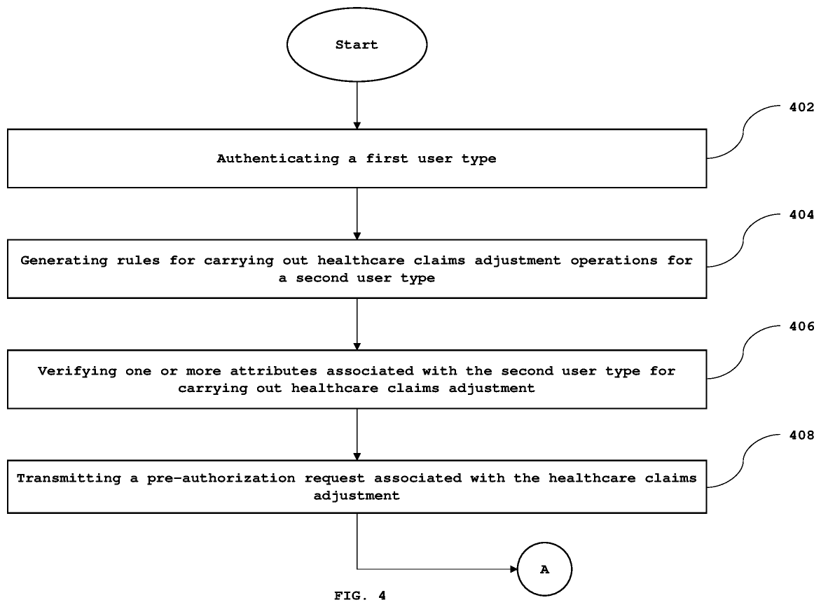

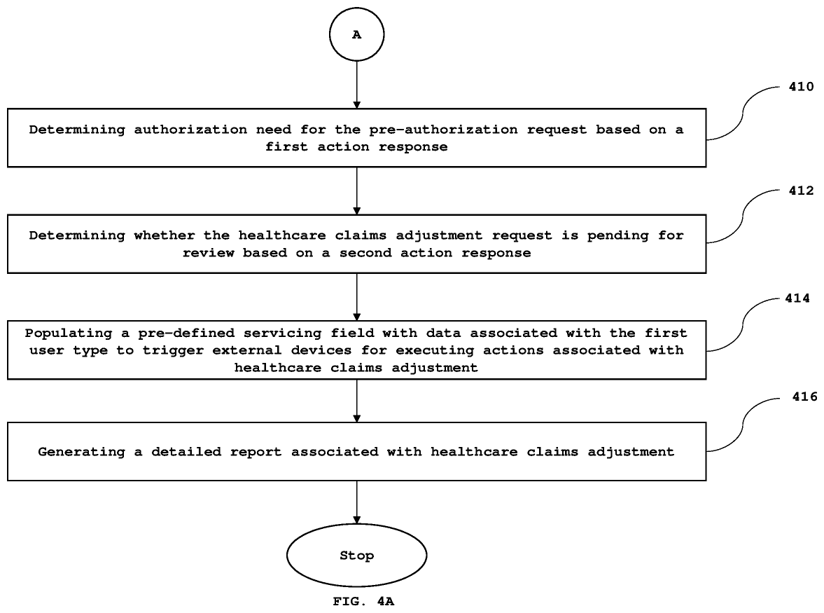

FIG. 4 and FIG. 4A is a flowchart illustrating a method for healthcare claims adjustment, in accordance with various embodiments of the present invention.

At step 402, a first user type is authenticated. In an embodiment of the present invention, one or more first user types are authenticated for providing access to the healthcare claims adjustment system based on administrative rights provided to the first user type. The first user type may include an administrative user or a provider, who manages the healthcare claims adjustment system. The first user type may use a Single Sign-On (SSO) functionality for accessing the system. Further, the first user type manages including, but not limited to, healthcare claims adjustments of an eligible second user type, access control of the second user type and the second user type group, access rights of the second type of users group, reset and editing rights of the second user type. The second user type includes a patient or a payer whose healthcare claim needs to be adjusted.

At step 404, one or more are rules generated for carrying out healthcare claims adjustment operations for a second user type. In an embodiment of the present invention, one or more rules comprises a first set, a second set, a third set and a fourth set of rules are generated, configured and developed based on pre-defined guidelines. Further, the one or more rules are implemented for carrying out healthcare claims adjustment operations in an automated manner. In an embodiment of the present invention, execution of the one or more rules is automated, thereby eliminating manual execution of the one or more rules. Further, real-time healthcare claims transaction updates, creating and updating healthcare claims adjustment documents, updating healthcare claims adjustment transaction status based on the one or more rules is carried out.

At step 406, one or more attributes associated with the second user type are verified for carrying out healthcare claims adjustment. In an embodiment of the present invention, bidirectional Application Programing Interfaces (APIs) are provided for verifying one or more attributes associated with the second user type healthcare claims adjustment requests, which are accessed by the second user type. The one or more attributes include, but are not limited to, eligibility of the second user type, healthcare claims coverage of the second user type and real-time identification of healthcare benefit plans, which aids in eliminating manual uploading of healthcare benefit plans, increasing automation efficiency and reducing administrative costs. The one or more claims adjustment requests may further include, but are not limited to, healthcare admission certificate requests and responses, referral requests and responses, healthcare services certification requests and responses, extending certification requests and responses and certification appeal requests and responses. Further, access to first user type data is provided to the first user type for authorization.

At step 408, a pre-authorization request associated with the healthcare claims adjustment is transmitted. In an embodiment of the present invention, a pre-authorization request associated with the healthcare claims adjustment is transmitted based on a first set of rules, which invokes a pre-authorization checking API via the APIs. Further, one or more requirements associated with the pre-authorization requests are verified using the pre-authorization checking API. The API provides correct authorization of healthcare claims adjustment requirements and a first user type contract status, thereby increasing automation and eliminating duplicate processes.

At step 410, a need for authorization for the pre-authorization request is determined based on a first action response. In an embodiment of the present invention, the APIs are used to determine whether authorization is needed for the pre-authorization request associated with the healthcare claims adjustment (such as, healthcare plan's contract and benefit terms) and the pre-authorization request are flagged as urgent or not urgent based on a second set of rules. A first action response is generated indicating a need for authorization need for the pre-authorization request. A ‘no plan action’ response is generated, if no authorization is needed.

At step 412, it is determined whether the healthcare claims adjustment request is pending for review based on a second action response. In an embodiment of the present invention, subsequent to receiving the first action response, a second action response is provided based on a third set of rules for determining whether the healthcare claims adjustment request is pending for review with a non-participating first user type. In an embodiment of the present invention, the first user type's contract status including a participating (par) or a non-participating (non-par) first user type is determined using the API.

In another embodiment of the present invention, the API further comprises a procedure and revenue (REV) code number for comparison with the health plan's benefit terms and contract terms. Further, first user type's ID data and pay-to-affiliate data associated with the first user type's contract status are also provided in the API. Further, if the first user type's ID data and the pay-to-affiliate data are not sent via the API, then the authorization need is compared with the healthcare plan's benefit terms.

At step 414, a pre-defined servicing field is populated with data associated with the first user type to trigger external devices for executing actions associated with healthcare claims adjustment. In an embodiment of the present invention, the API is implemented to search the first user type to populate a pre-defined servicing field with data associated with the first user type, via a GUI rendered on the electronic device of the first user type. The pre-defined servicing field comprises a servicing provider field or a servicing facility field. The pre-defined servicing field associated with the first user type is populated for performing healthcare claims adjustment. Further, in the event if more than one pay-to first user type affiliation is present for the first user type, then the results are displayed via the GUI. The first user type is prompted to select the appropriate pay-to first user type affiliation option, when multiple results are provided. For example, a drop-down field is provided on the authorization UI for selecting an appropriate pay-to first user type affiliate data for the servicing provider. Further, the selected pay-to first user type affiliate data is sent in the pre-authorization check API for a first level determination of authorization requirements for healthcare claims adjustment. In an exemplary embodiment of the present invention, in the event it is determined that authorization is required, then one or more gold-carding rules are reviewed in addition to the one or more rules. In another exemplary embodiment of the present invention, in the event it is determined that no authorization is needed for healthcare claims adjustment, then a dialogue box providing no authorization need is rendered on the GUI at the first user type's end. In an embodiment of the present invention, based on the populated data, external devices 124 are triggered by the electronic device to execute actions associated healthcare claim adjustments.

At step 416, a detailed report associated with healthcare claims adjustment is generated for the second user type. In an embodiment of the present invention, the GUI renders generation, viewing, assessing, exporting and printing of detailed healthcare claims adjustment report and summary of the healthcare claims adjustment report based on a fourth set of rules. In an embodiment of the present invention, the healthcare claims adjustment report is generated in an on-demand mode or a scheduled mode. In an exemplary embodiment of the present invention, the healthcare claims adjustment report is generated in an on-demand mode in the event the first user type selects a report generation option via the GUI. In another exemplary embodiment of the present invention, the healthcare claims adjustment report is generated in the scheduled mode in a pre-defined time period (e.g. report may be generated monthly). The generated reports include information including, but are not related to, a list of second user type, access attempts of the second user type, access logs of the second user type, second user type activity logs and second user type rights.

Advantageously, in accordance with various embodiments of the present invention, the present invention provides for optimized healthcare claims adjustment in real-time in an efficient manner with minimal human intervention. The present invention provides for an automated processing of large volumes of user healthcare claims adjustment data and transactions in a SaaS architecture. The present invention provides for real-time eligibility check for the second user type, real-time first user type information, real time creation and editing of authorization, real-time core system pre-authorization rule check, real-time automation of healthcare claims adjustment request authorization determination, real-time first user type referral processing, real-time prior authorization processing across core administration instances, and APIs that enable all range of core systems with utilization integration. The present invention provides for a consistent, predictable, easily implementable and maintainable healthcare claims adjustment instances. The present invention provides for determining urgency of the healthcare claims adjustment requests, whether the request is necessary or not. Further, the present invention provides for an updated healthcare claims adjustment data associated with the second user type. Furthermore, the present invention provides for generation and updating of healthcare claim adjustment requests which are transmitted to the core unit 120 in real-time, thereby expediting the claims adjustment process. Yet further, the present invention provides for APIs which enable all proprietary and non-proprietary core systems with utilization integration, thus providing wide range utilities. Furthermore, the present invention provides for automated designing, configuring, uploading and updating guidelines and rules associated with healthcare claims adjustment. Yet further, the present invention provides for creating, updating and viewing prior healthcare claims adjustment authorization transactions. Further, the present invention provides for automation of healthcare claims adjustment requests from submission to decision, thereby saving administrative time and cost of utilization management.

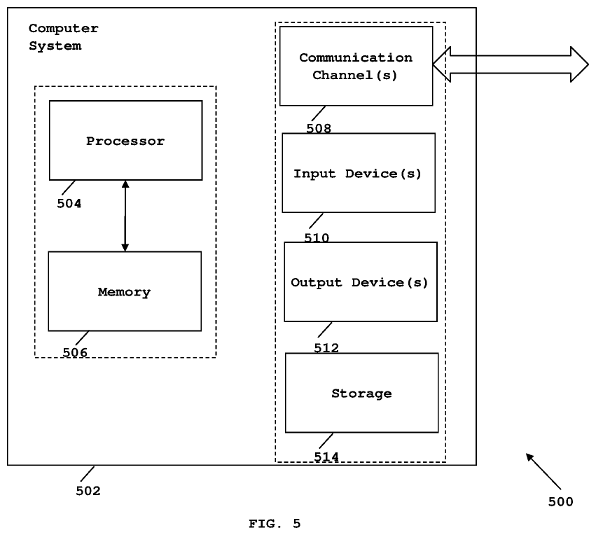

FIG. 5 illustrates an exemplary computer system in which various embodiments of the present invention may be implemented. The computer system 502 comprises a processor 504 and a memory 506. The processor 504 executes program instructions and is a real processor. The computer system 502 is not intended to suggest any limitation as to scope of use or functionality of described embodiments. For example, the computer system 502 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 506 may store software for implementing various embodiments of the present invention. The computer system 502 may have additional components. For example, the computer system 502 includes one or more communication channels 508, one or more input devices 510, one or more output devices 512, and storage 514. An interconnection mechanism (not shown) such as a bus, controller, or network, interconnects the components of the computer system 502. In various embodiments of the present invention, operating system software (not shown) provides an operating environment for various softwares executing in the computer system 502, and manages different functionalities of the components of the computer system 502.

The communication channel(s) 508 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 510 may include, but not limited to, a keyboard, mouse, pen, joystick, trackball, a voice device, a scanning device, touch screen or any another device that is capable of providing input to the computer system 502. In an embodiment of the present invention, the input device(s) 510 may be a sound card or similar device that accepts audio input in analog or digital form. The output device(s) 512 may include, but not limited to, a user interface on CRT or LCD, printer, speaker, CD/DVD writer, or any other device that provides output from the computer system 502.

The storage 514 may include, but not limited to, magnetic disks, magnetic tapes, CD-ROMs, CD-RWs, DVDs, flash drives or any other medium which can be used to store information and can be accessed by the computer system 502. In various embodiments of the present invention, the storage 514 contains program instructions for implementing the described embodiments.

The present invention may suitably be embodied as a computer program product for use with the computer system 502. The method described herein is typically implemented as a computer program product, comprising a set of program instructions which is executed by the computer system 502 or any other similar device. The set of program instructions may be a series of computer readable codes stored on a tangible medium, such as a computer readable storage medium (storage 514), for example, diskette, CD-ROM, ROM, flash drives or hard disk, or transmittable to the computer system 502, via a modem or other interface device, over either a tangible medium, including but not limited to optical or analogue communications channel(s) 508. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A system for automated healthcare claims adjustment in real-time, the system comprising:
a memory storing programing instructions;
a processor executing the program instructions stored in the memory; and
a healthcare claims adjustment engine executed by the processor and configured to:
transmit a pre-authorization request associated with a healthcare claims adjustment based on a first set of rules, wherein one or more requirements associated with the pre-authorization requests are verified using a pre-authorization checking Application Programing Interface (API);
determine a need for authorization for the pre-authorization request based on a second set of rules, wherein the need for authorization for the pre-authorization request is determined as a first action response;
perform a second action response based on a third set of rules, subsequent to the first action response, for determining whether the healthcare claims adjustment request is pending for review; and
populate a pre-defined servicing field with data associated with the first user type for performing healthcare claims adjustment, wherein external devices are triggered to execute actions associated with healthcare claims adjustment based on the populated data.

2. The system as claimed in claim 1, wherein the healthcare claims adjustment engine comprises an authentication unit executed by the processor and configured to communicate with a rules configuration unit in the healthcare claims adjustment engine for generating, configuring and developing one or more rules comprising the first set, second set and third set of rules based on pre-defined guidelines.

3. The system as claimed in claim 2, wherein the healthcare claims adjustment engine comprises a provider server executed by the processor and configured to communicate with the rules configuration unit in the healthcare claims adjustment engine for automating execution of the one or more rules.

4. The system as claimed in claim 3, wherein the provider server is configured to invoke a payer server in the healthcare claims adjustment engine which communicates with a common integration unit in the healthcare claims adjustment engine for carrying out real-time healthcare claims transaction updates, creating and updating healthcare claims adjustment documents, updating a core unit with healthcare claims adjustment transaction status based on the one or more rules.

5. The system as claimed in claim 1, wherein the healthcare claims adjustment engine comprises a core unit executed by the processor and configured to provide the bidirectional Application Programing Interfaces (APIs) for verifying one or more attributes associated with a second user type healthcare claims adjustment requests, and wherein the one or more attributes comprises eligibility of the second user type, healthcare claims coverage of the second user type and real-time identification of healthcare benefit plans.

6. The system as claimed in claim 5, wherein the core unit determines whether authorization is needed for the pre-authorization request associated with the healthcare claims adjustment using the APIs, and flags the pre-authorization request as ‘urgent’ or ‘not urgent’ based on the second set of rules, and wherein a common integration unit generates a ‘no plan action’ response if no authorization is needed.

7. The system as claimed in claim 1, wherein the second action response relates to determining whether the healthcare claims adjustment request is pending for review with a non-participating first user type, and wherein a common integration unit in the healthcare claims adjustment engine is configured to determine the first user type's contract status including a participating (par) or a non-participating (non-par) first user type, using the API.

8. The system as claimed in claim 5, wherein the APIs provided by the core unit comprises a procedure and revenue (REV) code number for comparison with a health plan's benefit terms and contract terms, and wherein the first user type's ID data and pay-to-affiliate data associated with the first user type's contract status are also provided in the APIs by the core unit, and wherein if the first user type's ID data and the pay-to-affiliate data are not sent via the APIs by the core unit, then the authorization need is compared with a healthcare plan's benefit terms.

9. The system as claimed in amended claim 2, wherein the pre-defined servicing field comprises a servicing provider field and a servicing facility field, and wherein in the event more than one pay-to first user type affiliation is present for the first user type, then the results are displayed via a Graphical User Interface (GUI) on an electronic device of the first user type, and wherein a selected pay-to first user type affiliate data is sent via a pre-authorization check API to a core unit in the healthcare claims adjustment engine for a first level determination of authorization requirements for healthcare claims adjustment, and wherein if authorization is required then one or more gold-carding rules are reviewed by a common integration unit in the healthcare claims adjustment engine in addition to the one or more rules present in the rules configuration unit.

10. The system as claimed in amended claim 1, wherein the healthcare claims adjustment engine comprises a reporting unit executed by the processor and configured to generate a detailed report for healthcare claims adjustment for a second user type, and wherein the reporting unit renders generation, viewing, assessing, exporting and printing of detailed healthcare claims adjustment report and summary of the healthcare claims adjustment report based on a fourth set of rules via a GUI.

11. The system as claimed in claim 10, wherein the reporting unit generates the healthcare claims adjustment report in an on-demand mode or a scheduled mode, and wherein the reporting unit generates the healthcare claims adjustment report in an on-demand mode in the event the first user type selects a report generation option via the GUI, and the reporting unit generates the healthcare claims adjustment report in the scheduled mode in a pre-defined time period, and wherein the generated reports include information related to, list of second user type, access attempts of the second user type, access logs of the second user type, second user type activity logs and second user type rights.

12. A method for automated healthcare claims adjustment in real-time, wherein the method is implemented by a processor executing program instructions stored in a memory, the method comprises:
transmitting a pre-authorization request associated with the healthcare claims adjustment based on a first set of rules, wherein one or more requirements associated with the pre-authorization requests are verified using a pre-authorization checking Application Programing Interface (API);
determining a need for authorization for the pre-authorization request based on a second set of rules, wherein the need for authorization for the pre-authorization request is determined as a first action response;
performing a second action response based on a third set of rules, subsequent to the first action response, for determining whether the healthcare claims adjustment request is pending for review; and
populating a pre-defined servicing field with data associated with the first user type for performing healthcare claims adjustment, wherein external devices are triggered to execute actions associated with healthcare claims adjustment based on the populated data.

13. The method as claimed in claim 12, wherein one or more rules comprising the first set, second set and third set of rules are generated, configured and developed based on pre-defined guidelines.

14. The method as claimed in claim 13, wherein real-time healthcare claims transaction updates, creating and updating healthcare claims adjustment documents, updating a core unit with healthcare claims adjustment transaction status are carried out based on the one or more rules.

15. The method as claimed in claim 12, wherein the bidirectional Application Programing Interfaces (APIs) are provided for verifying one or more attributes associated with a second user type healthcare claims adjustment requests, and wherein the one or more attributes comprises eligibility of the second user type, healthcare claims coverage of the second user type and real-time identification of healthcare benefit plans.

16. The method as claimed in claim 15, wherein the APIs are used to determine whether authorization is needed for the pre-authorization request associated with the healthcare claims adjustment and the pre-authorization request is flagged as ‘urgent’ or ‘not urgent’ based on the second set of rules, and wherein a ‘no plan action’ response is generated, if no authorization is needed.

17. The method as claimed in claim 12, wherein the second action response relates to determining whether the healthcare claims adjustment request is pending for review with a non-participating first user type, and wherein the first user type's contract status is determined including a participating (par) or a non-participating (non-par) first user type, using the API.

18. The method as claimed in claim 13, wherein the pre-defined servicing field comprises a servicing provider field and a servicing facility field, and wherein in an event if more than one pay-to first user type affiliation is present for the first user type, then the results are displayed via a Graphical User Interface (GUI), and wherein selected pay-to first user type affiliate data is sent via the pre-authorization check API for a first level determination of authorization requirements for healthcare claims adjustment, wherein if authorization is required then one or more gold-carding rules are reviewed in addition to the one or more rules.

19. The method as claimed in claim 12, wherein a detailed report for healthcare claims adjustment is generated for a second user type, and wherein generation, viewing, assessing, exporting and printing of detailed healthcare claims adjustment report and summary of the healthcare claims adjustment report is rendered via a GUI based on a fourth set of rules.

20. The method as claimed in claim 19, wherein the healthcare claims adjustment report is generated in an on-demand mode or a scheduled mode, and wherein the healthcare claims adjustment report is generated in an on-demand mode in the event the first user type selects a report generation option via the GUI, and the healthcare claims adjustment report is generated in the scheduled mode based on a pre-defined time period, and wherein the generated reports include information including a list of second user type, access attempts of the second user type, access logs of the second user type, second user type activity logs and second user type rights.

21. A computer program product comprising:
a non-transitory computer-readable medium having computer program code stored thereon, the computer-readable program code comprising instructions that, when executed by a processor, causes the processor to:
transmit a pre-authorization request associated with the healthcare claims adjustment based on a first set of rules, wherein one or more requirements associated with the pre-authorization requests are verified using a pre-authorization checking Application Programing Interface (API);
determine a need for authorization for the pre-authorization request based on a second set of rules, wherein the need for authorization for the pre-authorization request is determined as a first action response;
perform a second action response based on a third set of rules, subsequent to the first action response, for determining whether the healthcare claims adjustment request is pending for review; and
populate a pre-defined servicing field with data associated with the first user type for performing healthcare claims adjustment, wherein external devices are triggered to execute actions associated with healthcare claims adjustment based on the populated data.
